(19) United States
(12) Patent Application Publication
(10) Pub. No.: US 2003/0107584 A1
(43) Pub. Date: Jun. 12, 2003

(54) Security system and method for visual display

(75) Inventor: Edward O. Clapper, Tempe, AZ (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/020,335

(22) Filed: Dec. 12, 2001

(51) Int. Cl. G09G 5/00

(52) U.S. Cl. 345/619

(57) ABSTRACT

Improved methods for providing secure viewing of data in a computer system or computer network include blurring, or otherwise obscuring or reducing the legibility of, data in defined areas of the document to prevent nearby observers from viewing it. The defined areas can be determined by a variety of different factors, which can be set, for example, by the user and/or a system administrator. In one embodiment, an entire document, graphic image, or other type of displayed information is blurred, and only one or more relatively small user-defined viewing areas are legible to the user. In another embodiment, only sensitive areas of displayed information are blurred. The information-blurring effect can be implemented in different ways, such as through the particular software application, through the operating system, or through a custom or dedicated software module. Improved computers and computer networks for providing secure viewing of data are also described.

### TECHNICAL FIELD OF THE INVENTION

The present invention relates generally to the field of data processing and, more particularly, to improved systems and methods for providing secure viewing of information on a display.

### BACKGROUND OF THE INVENTION

When information is displayed to a user on a display, it is often desired to prevent uninvited observers from viewing the information, due to the sensitivity of the information. This is particularly problematic when the user is in a public place, such as on public transport, in a restaurant, in a waiting room, and so on, but it can also be a problem in the work place environment. A user may have to attempt to shield prying eyes from sensitive information, or the user may be forced to remove the sensitive information from the display until a later opportunity.

However, in an ever-shrinking world, and with ever-mounting time pressures, it is not always feasible to shield or delay viewing sensitive information, thus increasing the likelihood that it will be viewed by unintended observers.

For the reasons stated above, and for other reasons stated below which will become apparent to those skilled in the art upon reading and understanding the present specification, there is a significant need in the art for systems and methods that provide for the secure viewing of sensitive information on a display.

### BRIEF DESCRIPTION OF THE DRAWINGS

FIG. 1 illustrates a block diagram of a user device, and of an optional computer network comprising remote computing devices, that provide for secure viewing of data, in accordance with one embodiment of the invention;

FIG. 2 illustrates unmodified text in a defined area of a display window of a user device, in accordance with one embodiment of the invention;

FIG. 3 illustrates modified text in a defined area of a display window of a user device, in accordance with one embodiment of the invention;

FIG. 4 illustrates a flow diagram of a method of blurring graphic data for display, which method is implemented in a computer system, in a computer network, or in a computational machine operating under control of instructions residing on a machine-accessible medium, in accordance with various embodiments of the invention; and

FIGS. 5A and 5B together illustrate a flow diagram of methods of providing secure viewing of data, which methods are implemented in a computer system, in a computer network, or in a computational machine operating under control of instructions residing on a machine-accessible medium, in accordance with various embodiments of the invention.

### DETAILED DESCRIPTION OF EMBODIMENTS OF THE INVENTION

In the following detailed description of embodiments of the invention, reference is made to the accompanying drawings which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, procedural, mechanical, and electrical changes may be made without departing from the spirit and scope of the present inventions. The following detailed description is, therefore, not to be taken in a limiting sense, and the scope of the present invention is defined only by the appended claims.

The present invention provides for secure viewing of data in computer systems and via associated methods. Various embodiments are illustrated and described herein. According to one embodiment, an entire document, graphic image, or other type of displayed information is blurred, and only one or more relatively small user-defined viewing areas are legible and/or comprehensible to the user. In another embodiment, only sensitive areas of a document, graphic image, or other type of displayed information are blurred. The user-defined or sensitive areas can be determined by a variety of different factors, which can be set, for example, by the user and/or a system administrator.

The data modification effect (e.g. blurring) can be implemented in different ways, such as through the particular software application, through the operating system, or through a custom or dedicated software module. In one embodiment, data modification is performed on data that has been formatted (e.g. pixelated) prior to being displayed as information on a display such as a raster-scan display.

The term “blurred”, as used herein, means the legibility of information displayed on a display has been modified.

In one embodiment, information being displayed on a display is illegible to an uninvited observer in the vicinity of a user device. Depending upon the degree or type of blurring, which in some embodiments can be changed by the device user and/or system administrator, displayed information may or may not also be illegible to the device user.

In one embodiment, displayed information may be virtually illegible to the device user and yet still comprehensible to the device user, particularly if the device user has previously viewed the information in an unblurred state, because the overall formatting of the blurred information remains the same as for the unblurred information.

The improved document viewing methods and apparatus are inexpensive and adaptable, and they can significantly increase the commercial value of computer software, computer systems, and/or computer networks in which they are featured.

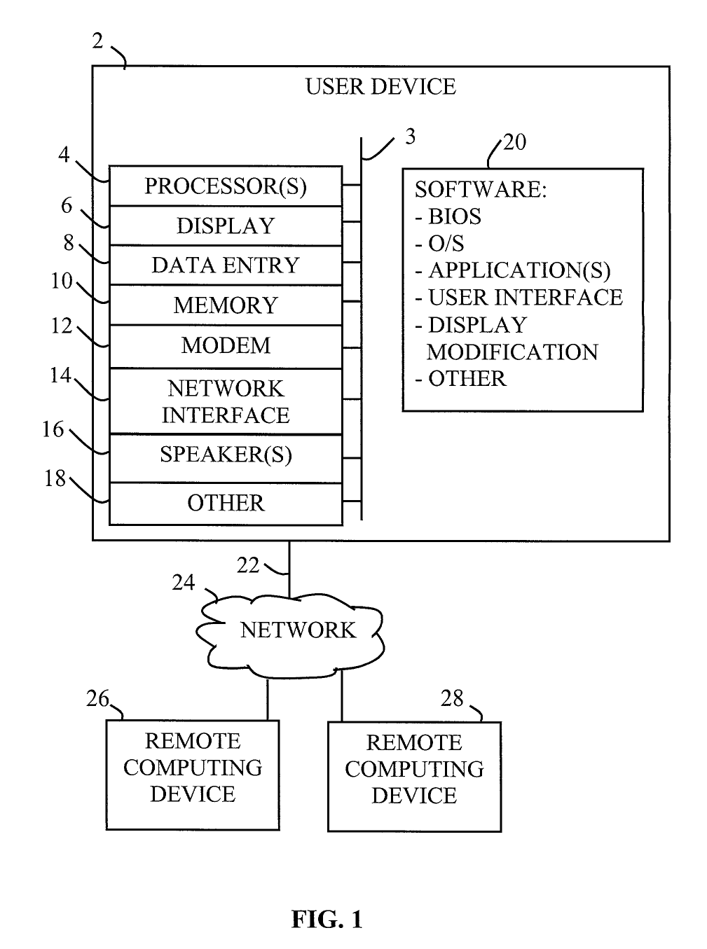

FIG. 1 illustrates a block diagram of a user device 2, and of an optional computer network 24 comprising remote computing devices 26 and 28, that provide for secure viewing of data, in accordance with one embodiment of the invention.

FIG. 1 and the following discussion are intended to provide a brief, general description of a suitable computing environment in which certain aspects of the illustrated invention may be implemented. An exemplary system to provide secure viewing of information includes a machine or user device 2 having system bus 3. Typically, attached to bus 3 are one or more processors 4, a display 6, and one or more data entry elements 8 such as a keyboard, mouse, trackball, joy stick, touch-sensitive screen, or the like. Also attached to bus 3 is a memory 10, which can include any suitable memory device(s) like read only memory (ROM); random access memory (RAM); hard drive; removable media drive for handling compact disks (CDs), digital video disks (DVDs), diskettes, magnetic tape cartridges, and other types of data storage; or the like. Additional elements can also be attached to bus 3 such as a modem 12, a network interface unit 14, one or more speakers 16, and other suitable devices 18.

“Processor”, as used herein, means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit. The term also includes embedded controllers, such as Generic or Programmable Logic Devices or Arrays, Application Specific Integrated Circuits, single-chip computers, smart cards, and the like.

“Suitable”, as used herein, means having characteristics that are sufficient to produce the desired result(s). Suitability for the intended purpose can be determined by one of ordinary skill in the art using only routine experimentation.

User device 2 can optionally operate in a networked environment using a physical and/or a logical connection 22 to one or more remote computing devices or systems 26 and 28 via wired or wireless network 24. Network 24 can be an intranet; the Internet; a local area network; a wide area network; a cellular, cable, laser, satellite, microwave, “Blue Tooth”, optical, or infrared network; or any other short-range or long-range wired or wireless network.

The invention may be implemented in conjunction with program modules, including functions, procedures, data structures, application programs, etc. for performing tasks, or defining abstract data types or low-level hardware contexts. Program modules may be stored in memory 10 and associated storage media, e.g., hard-drives, floppy-disks, optical storage, magnetic cassettes, tapes, flash memory cards, memory sticks, digital video disks, chemical storage, and/or biological storage. Program modules may be delivered over transmission environments, including network 24, in the form of packets, serial data, parallel data, propagated signals, etc. Program modules may be used in a compressed or encrypted format, and they may be used in a distributed environment and stored in local and/or remote memory, for access by single and multi-processor machines, portable computers, handheld devices (e.g., Personal Digital Assistants (PDAs)), cellular telephones, pagers, personal entertainment devices (e.g. digital music players), one-way or two-way radios, or the like.

Thus, for example, with respect to the illustrated embodiments, assuming that user device 2 provides secure viewing of display information, then one or both of remote computing devices 26 and 28 may be configured like user device 2, and they can include many or all of the elements discussed for user device 2. One of remote computing devices 26 and 28 could also be operated by a system administrator, for example, to establish system-wide or user-specific rules for what displayed information should be protected, as well as when and how it should be secured from uninvited viewing. It should also be appreciated that while devices 2, 26, and 28 are typically separate communicatively-coupled components they could be embodied within a single device.

Devices 2, 26, and 28 can further comprise a plurality of types of software programs. For example, user device 2 can comprise software 20 that includes a basic input/output system (BIOS), operating system (O/S) software, one or more software applications, a user interface, display modification software, and any other types of software as required to perform the operational requirements of user device 2.

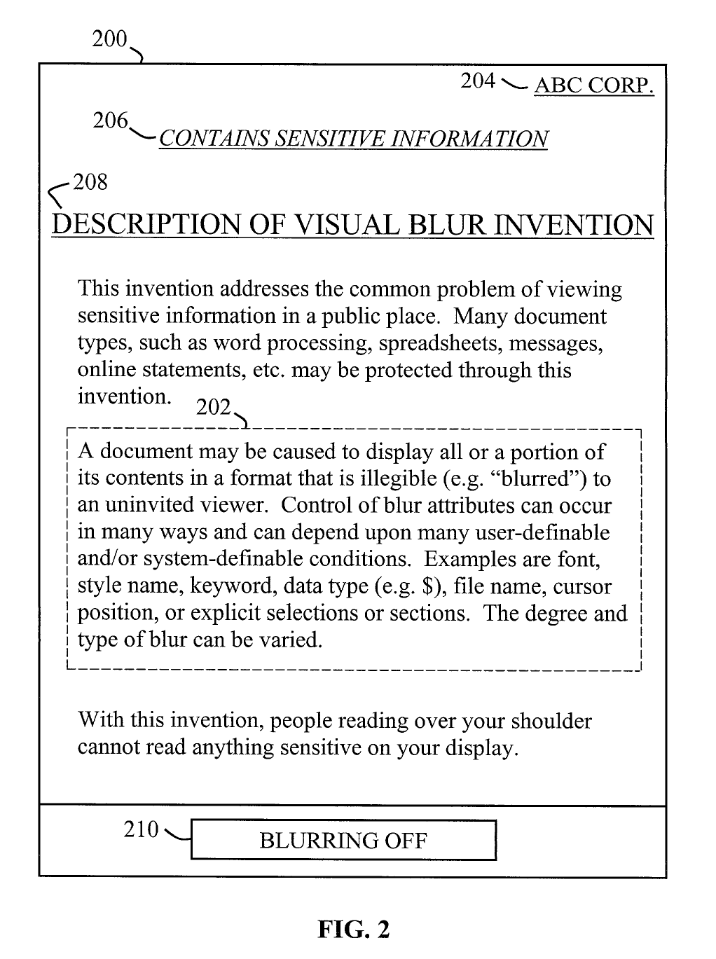

FIG. 2 illustrates unmodified text in a defined area 202 of a display window 200 of a user device, in accordance with one embodiment of the invention. The example shown in FIG. 2 is merely one type of data or information that can be displayed to a user of user device 2 (FIG. 1). Still referring to FIG. 2, a defined area 202 contains sensitive information that should not be viewed by uninvited viewers. In the example of FIG. 2, the information in defined area 202 remains unmodified or unblurred. This status is indicated by a notification to the user within window 210 indicating “Blurring Off”. This notification is optional, but if implemented, it can be provided in any suitable way, such as an on-screen window, a light-emitting diode (LED) on the user device, etc.

Also shown in FIG. 2 are several categories of text data that can optionally contain data attributes to enable blurring, disable blurring, or adjust the degree of blurring. For example, header 204 “ABC CORP.”, legend 206 “CONTAINS SENSITIVE INFORMATION”, and title 208 “DESCRIPTION OF VISUAL BLUR INVENTION” constitute different types of text data, namely header 204, legend 206, and title 208. The presence of any or all of these text data types can be used to switch blurring on or off. Conversely, the absence of any or all of these text data types could be used to switch blurring on or off. For example, a legend 206 saying “UNRESTRICTED” could switch blurring off, while a legend 206 saying “CONTAINS SENSITIVE INFORMATION” could switch blurring on.

Similarly, other attributes of text data can function to enable, disable, or modify blurring. These attributes include font (e.g. font size, font type, font color, boldface, italics, underlining, etc.), paragraph (formatting, line spacing, etc.), page (e.g. page number, page type, etc.), document (e.g. document name, document type, etc.), user name (e.g. the log-in name of the current user), user location (i.e., the current user's physical location, such as at the office, at home, undocked, docked, etc.), device name (e.g. type of user device being used), date, time, style name (e.g. type of formatting style, such as title, subtitle, body, header, footer, etc.), data type (e.g. text, numerical, currency, etc.), text (e.g. keyword, specific character string, etc.), field (e.g. specific field or fields within a database record, etc.), file name, and cell (e.g. specific cell or cells within a spreadsheet, etc.).

As one example of how font attributes can be used to enable or disable blurring, legend 206 appears in italicized font, and this font attribute (i.e. italics) can be utilized to either reduce legibility or to restore legibility. As another example, title 208 appears in large font, and this font attribute (i.e. size) can be utilized to either reduce legibility or to restore legibility.

As one example of how text (e.g. a keyword or character string) can be used to enable or disable legibility, blurring could be enabled or disabled whenever a specific word, phrase, number, etc. appears on the display.

As one example of how a combination of attributes can be used to enable or disable blurring, a style name (e.g. body) could be used to enable blurring, while concurrently a font (e.g. bold) could be used to override blurring, so that all bolded words within a text body remain unblurred; alternatively, all bolded words could have a more pronounced blurring than the adjoining text. Many other combinations of two or more of the above-mentioned attributes could also be used to enable or disable legibility.

One of ordinary skill in the art is capable of writing suitable computer program instructions, for storage on suitable storage media, which when accessed by a processor or other computational machine result in information being displayed in a blurred manner on a display, such as display 6 (FIG. 1), or which result in information being displayed in a legible manner, depending in part upon the value of attributes as described above.

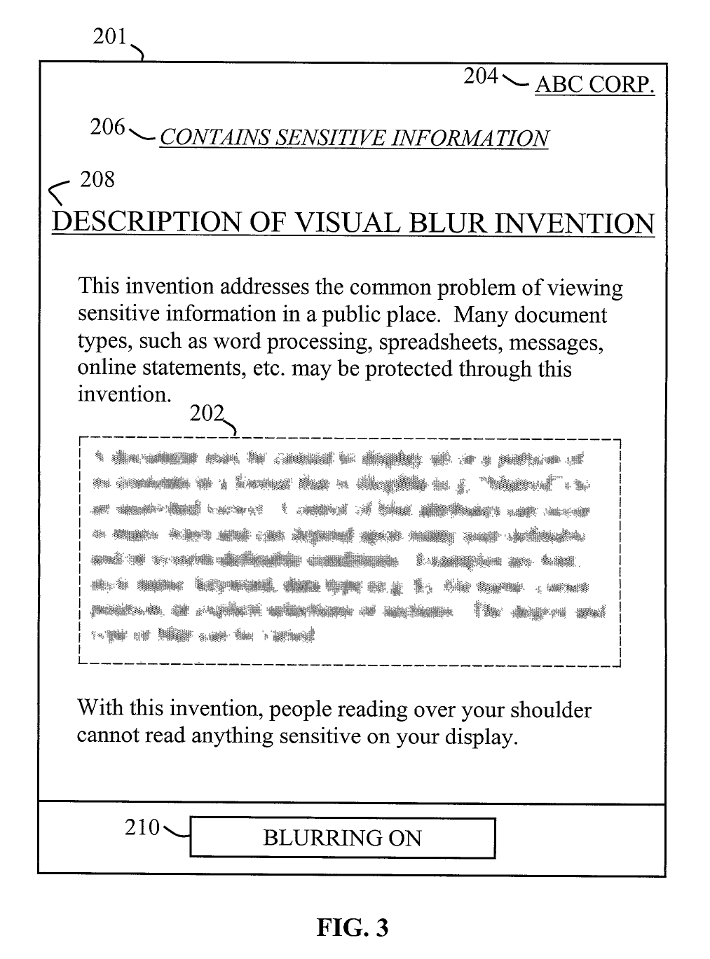

FIG. 3 illustrates modified text in a defined area 202 of a display window 201 of a user device, in accordance with one embodiment of the invention. In this example, the text appearing in defined area 202 of display window 201 has been modified or blurred to prevent uninvited observers from viewing it. This status is indicated by a notification to the user within optional window 210 indicating “Blurring On”. In the example shown in FIG. 3, a Gaussian blur has been applied to the text appearing in defined area 202 of display window 201. The visual effect is to make the text appear fuzzy or out of focus to a viewer.

In addition to using data attributes to modify or unmodify data to be displayed, data can additionally or alternatively be modified and/or unmodified in accordance with a suitable hardware or software control signal from any suitable user interface element. Examples of user actions and user-actuated equipment that could initiate a suitable control signal include the position of a cursor on the user's display screen. For example, moving the cursor into a defined area such as defined area 202 in FIG. 3 could cause the text to become legible; alternatively, moving the cursor into a defined area such as defined area 202 of FIG. 2 could cause the text to become either blurred or totally illegible.

In other embodiments, moving a cursor over a single word, line, paragraph, page, etc. could accordingly cause the information (text, numbers, etc.) to become illegible. Conversely, the entire document or file could be normally illegible, and suitable user action, such as moving a cursor over the information, could cause the information to be come legible. For example, moving the cursor over a given line could cause that line, as well as the lines immediately before and after to become legible. The invention can be implemented in any suitable manner, depending only upon the desires of those who wish to practice it.

In addition to cursor position, the modification of data could be triggered by other user responses, such as touching of or movement of a pointing device (e.g. a mouse, trackball, joy stick, etc.), a key or button depression, choosing an item from a display menu, clicking on a screen icon, speaking into a microphone, depressing an area on a touch-sensitive screen, or any combination of the above responses.

In FIG. 3, the modified text in defined area 202 of display window 201 illustrates how displayed information may be virtually illegible to the device user and yet still comprehensible to the device user, particularly if the device user has previously viewed the information in an unblurred state. For example, the last sentence in defined area 202 is “The degree and type of blur can be varied”. Once the device user has read this sentence in an unblurred form, for example in defined area 202 of the example shown in FIG. 2, the device user can readily comprehend the sentence in its blurred form. This is due, in part, to the fact that the overall formatting of the blurred information remains the same as for the unblurred information. That is, the font size, the relative length and location of the words, and other visual cues (e.g. capital letters, letters having extenders such as “g” and “y”, other characteristic shapes of letters, punctuation, and so forth) remain substantially constant. The device user can, if desired, adjust the degree of information modification so that the device reader can comprehend the information but an uninvited observer cannot comprehend the information.

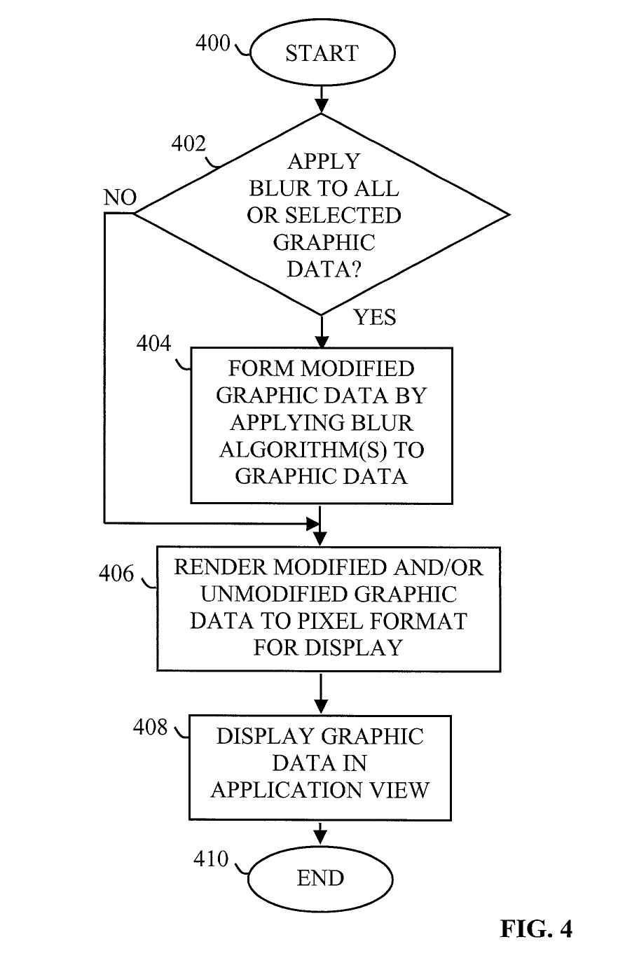

FIG. 4 illustrates a flow diagram of a method of blurring graphic data for display, which method is implemented in a computer system, in a computer network, or in a computational machine operating under control of instructions residing on a machine-accessible medium, in accordance with various embodiments of the invention. The method is merely one example of applying a blurring operation to graphic data to be displayed on a display. Many other implementations are also possible, as will be apparent to those of ordinary skill in the art.

The term “graphic data”, as used herein, means any type of information that is capable of being displayed. Examples include but are not limited to text (e.g. formatted alphanumeric characters such as documents, spreadsheets, emails, and messages), computer-generated graphical images (e.g. lines, circles, curves, other geometric shapes, and any combination thereof including computer-aided designs, presentation graphics, computer art, computer models, simulations, and video games), and processed pre-existing images (e.g. photographs, X-rays, video works, and cinematic works).

The method starts at 400. The method assumes that graphic data has already been generated, e.g. by an application such as a word processor, spreadsheet, email, graphics generating and/or editing program, or other application, and is digitally stored.

In 402, a determination is made whether to modify (e.g. apply blur to) the graphic data or a selected portion thereof. If so, the method goes to 404; otherwise, it goes to 406.

In 404, modified graphic data is formed by applying one or more blur algorithms to the graphic data. Algorithms to modify graphic data are commercially available. For example, algorithms to apply a Gaussian blur are commonly available as part of image editing applications, such as Adobe Photoshop 5.5 which is currently available from Adobe Corp., whose URL is www-adobe-com (hyphens have been substituted for dots to avoid unintended hyperlinks).

Another example of a blurring algorithm is one that causes graphic data to be displayed as a geometric outline. That is, the text “This is secure data” would be displayed as a solid block having approximately the same footprint (i.e. physical length and height) as the unmodified graphic data but comprising no discernible alphanumeric characters. Many variations are possible. For example, any desired “fill” pattern may be used within the footprint of the unmodified graphic data to represent to the viewer that the unmodified graphic data has been replaced with blurred data.

Another example of a blurring algorithm is one that causes graphic data to be displayed as a dynamically “vibrating” object on the display screen. Again, the degree of movement is controllable by the device user and/or system administrator, so that at one extreme the graphic data is still barely legible to the device user (but not to an uninvited observer) while at the other extreme the graphic data is “vibrating” to such an extent that it is not legible to the device user.

In 406, modified and/or unmodified graphic data is rendered to pixel format in preparation for display.

In 408, the graphic data is displayed on the display in the appropriate view or window of the particular application. The method ends at 410.

The operations of FIG. 4 could be performed in a different order. For example, in an alternative embodiment, operation 404 could be performed after operation 406. That is, one or more blur algorithms could be applied to pixelated graphic data. This can be in addition to applying one or more blur algorithms to the graphic data prior to converting the graphic data to pixel format.

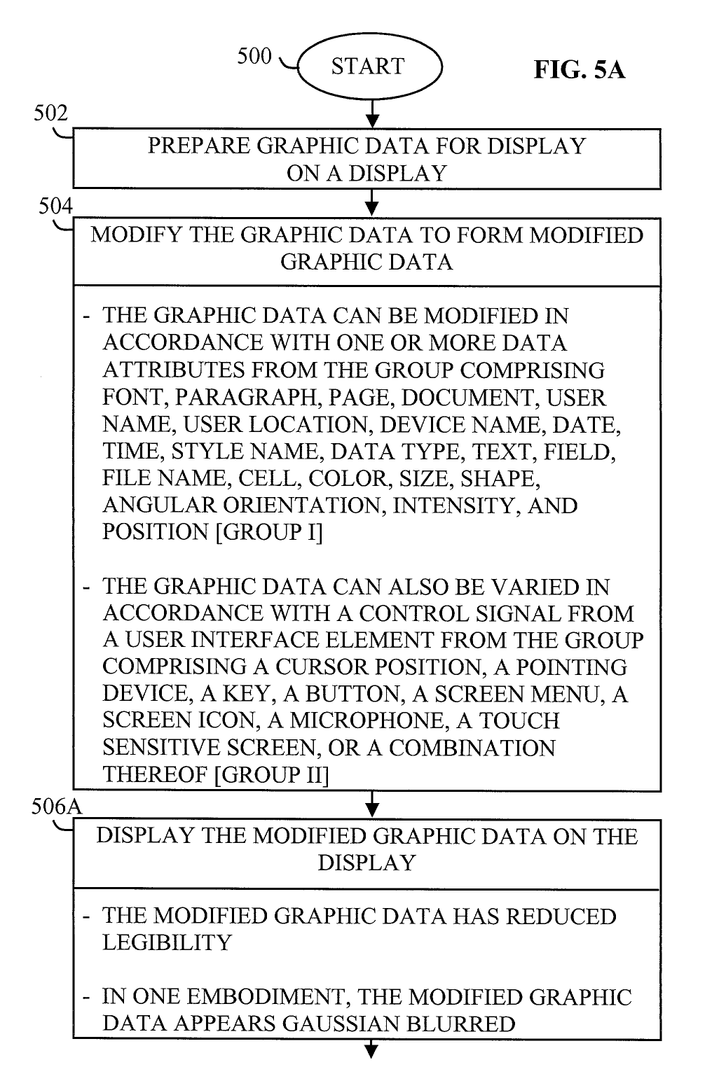

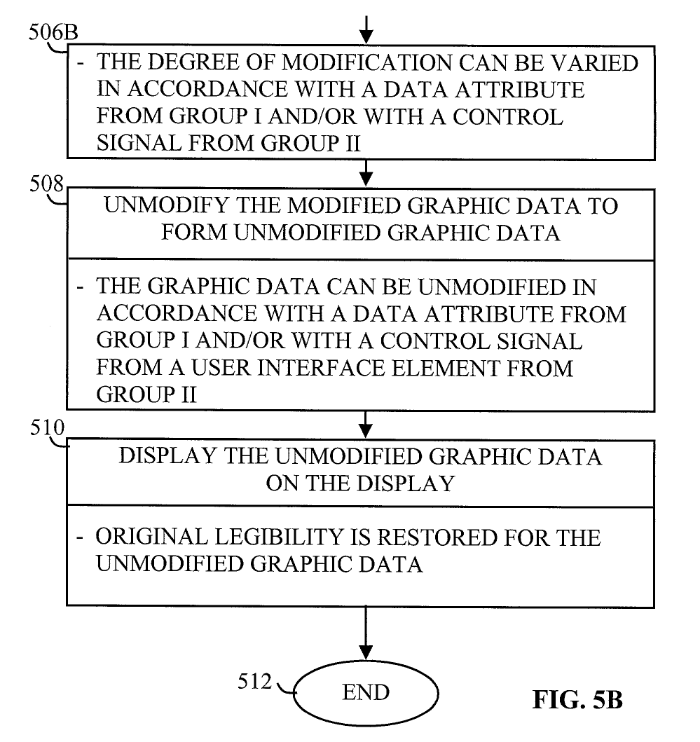

FIGS. 5A and 5B together illustrate a flow diagram of methods of providing secure viewing of data, which methods are implemented in a computer system, in a computer network, or in a computational machine operating under control of instructions residing on a machine-accessible medium, in accordance with various embodiments of the invention. The methods begin at 500.

In 502, graphic data is prepared for display on a display, such as a display screen of any of the exemplary types of user devices mentioned above. Typically, graphic data is prepared for display in accordance with a particular user application, such as a spreadsheet, email, word processing, financial statement, database, instant messaging, cell phone, pager, or other application.

In 504, the graphic data is modified to form modified graphic data. For example, as described earlier, the text graphic data can be modified in accordance with one or more data attributes, such as font, paragraph, page, document, user name, user location, device name, date, time, style name, data type, text, field, file name, and cell. Computer-generated graphical images and processed pre-existing images can also be modified in accordance with one or more data attributes, such as color, size, shape, angular orientation, intensity, and position. For example, a computer-generated graphic image of a new machine part can be displayed in a low intensity and/or a barely perceptible color, within the context of an overall machine of which it forms a part, so that it can only be viewed by the device user. For convenience of description, these attributes are referred to as Group I.

The graphic data can also be varied in accordance with a hardware or software control signal from a user interface element. For example, as described earlier, the graphic data can be modified (e.g. to make it illegible or to make it legible) depending upon a cursor position, the position of a pointing device (e.g. a mouse, trackball, joystick, etc.), depression of a key or button, selection of an item from an on-screen menu, selection of a screen icon, speaking into a microphone, touching an area of a touch-sensitive screen, or any combination of the above. For convenience of description, these representative user-initiated actions are referred to as Group II.

In 506A, the modified graphic data is displayed on the display. The modified graphic data has reduced legibility. The modified graphic data is illegible to an uninvited viewer viewing the display. In one embodiment, the modified graphic data appears Gaussian blurred, as exemplified by the text appearing in defined area 202 of display window 201 (FIG. 3). Applying a Gaussian blur is merely one type of data modification with which to make data illegible. Other types of data modification can be made, including applying any one or more of the data attributes of Group I.

In 506B, which is a continuation of operation 506A, the degree of modification can be varied in accordance with a data attribute from Group I and/or with a control signal from Group II.

In 508, the modified graphic data can be unmodified to form unmodified graphic data. The graphic data can be unmodified in accordance with a data attribute from Group I and/or with a control signal from a user interface element from Group II. For example, graphic data can be unmodified based upon the time of day or calendar date. As another example, graphic data can be unmodified based upon the user's cursor position on the display or based upon the device name.

In 510, the unmodified graphic data is displayed on the display. Such unmodified graphic data is legible to viewers of the display. The methods end at 512.

It should be understood that the operations shown in FIGS. 4 and 5A-5B are merely representative and not exclusive, and that many other different alternative operations could be implemented using the concepts taught by the present invention.

The operations described above with respect to the methods illustrated in FIGS. 4 and 5A-5B can be performed in a different order from those described herein. Also, it will be understood that although the methods are described as having an “end”, they typically are continuously performed.

Enabling and disabling viewable data on a display is carried out by suitable instructions in one or more computer programs that are stored in and executed by one or more devices 2, 26, and 28 in FIG. 1. One of ordinary skill in the art is capable of writing suitable instructions to implement the objectives and features of the invention as described herein.

### CONCLUSION

The present invention provides for secure viewing of data in computer systems and associated methods. Various embodiments have been illustrated and described herein. According to one embodiment, an entire document, graphic image, or other type of displayed information is blurred, and only one or more relatively small user-defined viewing areas are legible to the user. The defined areas can be determined by a variety of different factors, which can be set, for example, by the user and/or a system administrator. In another embodiment, only sensitive areas of displayed information are blurred. The data modification effect can be implemented in different ways, such as through the particular software application, through the operating system, or through a custom or dedicated software module.

Improved methods for providing secure viewing of data have been described. In addition, improved computers and computer networks for providing secure viewing of data have also been described. The improved methods and apparatus for securely viewing data are inexpensive and adaptable, and they can significantly increase the commercial value of computer software, computer systems, and/or computer networks in which they are included.

Other embodiments will be readily apparent to those of ordinary skill in the art. The elements, architecture, and sequence of operations can all be varied to suit particular data security requirements.

The various elements depicted in the drawings are merely representational and are not drawn to scale. Certain proportions thereof may be exaggerated, while others may be minimized. The drawings are intended to illustrate various implementations of the invention, which can be understood and appropriately carried out by those of ordinary skill in the art.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment”, “in another embodiment”, or the like are used herein, these phrases are meant to generally reference embodiment possibilities, and they are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and it should not be taken as limiting the scope of the invention.

Although specific embodiments have been illustrated and described herein, it will be appreciated by those of ordinary skill in the art that any arrangement or process that is calculated to achieve the same purpose may be substituted for the specific embodiments shown. This application is intended to cover any adaptations or variations of the present invention. Therefore, it is manifestly intended that this invention be limited only by the claims and the equivalents thereof.

What is claimed is:

1. A method comprising:
preparing data for display on a display;
modifying the data to form modified data; and
displaying the modified data on the display, the modified data having reduced legibility.

2. The method recited in claim 1 wherein, in modifying, the data is modified in accordance with one or more data attributes from the group comprising font, paragraph, page, document, user name, user location, device name, date, time, style name, data type, text, field, file name, cell, color, size, shape, angular orientation, intensity, and position.

3. The method recited in claim 1 and further comprising:
unmodifying the modified data to form unmodified data; and
displaying the unmodified data on the display, the unmodified data being legible.

4. The method recited in claim 3 wherein, in unmodifying, the data is unmodified in accordance with a control signal from a user interface element from the group comprising a cursor position, a pointing device, a key, a button, a screen menu, a screen icon, a microphone, a touch sensitive screen, or a combination thereof.

5. The method recited in claim 1 wherein, in displaying, the modified data is blurred.

6. The method recited in claim 5 wherein, in modifying, a degree of blur is varied in accordance with a data attribute from the group comprising font, paragraph, page, document, user name, user location, device name, date, time, style name, data type, text, field, file name, cell, color, size, shape, angular orientation, intensity, and position.

7. The method recited in claim 5 wherein, in modifying, a degree of blur is varied in accordance with a control signal from a user interface element from the group comprising a cursor position, a pointing device, a key, a button, a screen menu, a screen icon, a microphone, a touch sensitive screen, or a combination thereof.

8. A computer including a memory to store data, and a user interface including a display, the computer executing a computer program comprising the operations of:
preparing data for display on the display;
modifying the data to form modified data; and
displaying the modified data on the display, the modified data being illegible.

9. The computer recited in claim 8, wherein the data comprises one or more data attributes, and wherein, in modifying, the computer program comprises the operation of modifying the data in accordance with one or more data attributes from the group comprising font, paragraph, page, document, user name, user location, device name, date, time, style name, data type, text, field, file name, cell, color, size, shape, angular orientation, intensity, and position.

10. The computer recited in claim 8, wherein the computer program further comprises the operations of:
unmodifying the modified data to form unmodified data; and
displaying the unmodified data on the display, the unmodified data being legible.

11. The computer recited in claim 10 wherein, in unmodifying, the computer program comprises the operation of unmodifying the data in accordance with a control signal from a user interface element from the group comprising a cursor position, a pointing device, a key, a button, a screen menu, a screen icon, a microphone, a touch sensitive screen, or a combination thereof.

12. The computer recited in claim 8 wherein, in displaying, the computer program comprises the operation of blurring the modified data.

13. The computer recited in claim 12, wherein the data comprises one or more data attributes, and wherein the computer program, in the modifying operation, varies a degree of blur in accordance with a data attribute from the group comprising font, paragraph, page, document, user name, user location, device name, date, time, style name, data type, text, field, file name, cell, color, size, shape, angular orientation, intensity, and position.

14. The computer recited in claim 12 wherein the computer program, in the modifying operation, varies a degree of blur in accordance with a control signal from a user interface element from the group comprising a cursor position, a pointing device, a key, a button, a screen menu, a screen icon, a microphone, a touch sensitive screen, or a combination thereof.

15. A computer network including a user device having a memory to store data and a user interface including a display, and a remote computing device, the computer network executing a computer program residing on the remote computing device comprising the operations of:
preparing data for display on the display;
modifying the data to form modified data; and
displaying the modified data on the display, the modified data being illegible.

16. The computer network in claim 15, wherein the data comprises one or more data attributes, and wherein, in modifying, the computer program comprises the operation of modifying the data in accordance with one or more data attributes from the group comprising font, paragraph, page, document, user name, user location, device name, date, time, style name, data type, text, field, file name, cell, color, size, shape, angular orientation, intensity, and position.

17. The computer network recited in claim 15, wherein the computer program further comprises the operations of:
unmodifying the modified data to form unmodified data; and
displaying the unmodified data on the display, the unmodified data being legible.

18. The computer network recited in claim 17 wherein, in unmodifying, the computer program comprises the operation of unmodifying the data in accordance with a control signal from a user interface element from the group comprising a cursor position, a pointing device, a key, a button, a screen menu, a screen icon, a microphone, a touch sensitive screen, or a combination thereof.

19. The computer network recited in claim 15 wherein, in displaying, the computer program comprises the operation of blurring the modified data.

20. The computer network recited in claim 19, wherein the data comprises one or more data attributes, and wherein the computer program, in the modifying operation, varies a degree of blur in accordance with a data attribute from the group comprising font, paragraph, page, document, user name, user location, device name, date, time, style name, data type, text, field, file name, cell, color, size, shape, angular orientation, intensity, and position.

21. The computer network recited in claim 19 wherein the computer program, in the modifying operation, varies a degree of blur in accordance with a control signal from a user interface element from the group comprising a cursor position, a pointing device, a key, a button, a screen menu, a screen icon, a microphone, a touch sensitive screen, or a combination thereof.

22. An article comprising a machine-accessible medium having associated instructions, wherein the instructions, when accessed, result in a machine performing:
preparing data for display on a display;
modifying the data to form modified data; and
displaying the modified data on the display, the modified data having reduced legibility.

23. The article of claim 22, wherein the data comprises one or more data attributes, and wherein the instructions, when accessed by the machine, result in the machine performing:
in modifying, modifying the data in accordance with one or more data attributes from the group comprising font, paragraph, page, document, user name, user location, device name, date, time, style name, data type, text, field, file name, cell, color, size, shape, angular orientation, intensity, and position.

24. The article of claim 22, wherein the machine-accessible medium further includes instructions which, when accessed by the machine, result in the machine performing:
unmodifying the modified data to form unmodified data; and
displaying the unmodified data on the display, the unmodified data being legible.

25. The article recited in claim 24 wherein the instructions, when accessed by the machine, result in the machine performing:
in unmodifying, unmodifying the data in accordance with a control signal from a user interface element from the group comprising a cursor position, a pointing device, a key, a button, a screen menu, a screen icon, a microphone, a touch sensitive screen, or a combination thereof.

26. The article recited in claim 22 wherein the instructions, when accessed by the machine, result in the machine performing:
in displaying, blurring the modified data.

27. The article recited in claim 26, wherein the data comprises one or more data attributes, and wherein the instructions, when accessed by the machine, result in the machine performing:
in modifying, varying a degree of blur in accordance with a data attribute from the group comprising font, paragraph, page, document, user name, user location, device name, date, time, style name, data type, text, field, file name, cell, color, size, shape, angular orientation, intensity, and position.

28. The article recited in claim 26, wherein the instructions, when accessed by the machine, result in the machine performing:
in modifying, varying a degree of blur in accordance with a control signal from a user interface element from the group comprising a cursor position, a pointing device, a key, a button, a screen menu, a screen icon, a microphone, a touch sensitive screen, or a combination thereof.
